(19) United States
(12) Patent Application Publication
(10) Pub. No.: US 2017/0270512 A1
(43) Pub. Date: Sep. 21, 2017

(54) Design framework for badge proximity discovery system

(71) Applicants: Glenn Robert Seidman, Woodside, CA (US); Rajest A. Patel, Redwood City, CA (US); Denise Anne Holt, Pleasonton, CA (US); Ragin Thakorbhai Desai, San Jose, CA (US)

(72) Inventors: Glenn Robert Seidman, Woodside, CA (US); Rajest A. Patel, Redwood City, CA (US); Denise Anne Holt, Pleasonton, CA (US); Ragin Thakorbhai Desai, San Jose, CA (US)

(73) Assignee: Gratzeez, LLC, Redwood City, CA (US)

(21) Appl. No.: 14/999,037

(22) Filed: Mar. 21, 2016

(51) Int. Cl. G06Q 20/32; G06F 17/30; G06F 21/62; H04L 12/24

(52) U.S. Cl. CPC G06Q 20/3276; H04L 41/026; G06Q 20/3224; G06F 17/30867; G06F 21/6245

(57) ABSTRACT

A computer-implemented method that requires an inventive special-purpose software apparatus is disclosed. The apparatus comprises software subsystems that facilitate discovery of people wearing badges because they are service providers in a specific vicinity and want to be found easily by consumers employing their services so that the consumers may submit gratuities easily, quickly, and electronically to them.

### CROSS-REFERENCE TO RELATED APPLICATIONS

This patent application claims the benefit of U.S. Provisional Patent No. 62/177,808 filed Mar. 24, 2015. The content of U.S. Provisional Patent No. 62/177,808 is incorporated herein by reference.

### TECHNICAL FIELD OF THE INVENTION

The present invention pertains to badge environments for the purpose of facilitating knowing when persons wearing a badge are proximal to other persons running a mobile application.

### BACKGROUND OF THE INVENTION

Badges have been employed for many uses and there are many types of badges. For wireless badges, a common use is to facilitate secure entry through locked doors. Another common use is for the transmission and reception of various communication or data, typically in medical environments. Non-electronic badges are everywhere and many have QR or barcodes on them to quickly scan a person's identity at a conference, office, or other function. One untapped use of badges is for the Service Provider community. This community includes those persons we see everyday at restaurants, hotels, hair salons, car washes, etc. It will be shown that there is a need to employ Service Provider badges for the purpose of knowing who is on duty and nearby in order to submit a gratuity to them easily

A common problem for the service provider community is that many services don't or can't involve credit cards, only cash for gratuities. While electronic money exchanges take place everyday via mobile phones from one person to another, there is no easy way to know who to send money to someone you meet briefly at a service location. To do so, one either requires an email address or userId for the service provider to tip. However, both the service provider and the consumer are often strangers and don't want to share contact information like email, and even if a userId is employed, it must be typed in and so the tipping process becomes cumbersome. Additionally, many service providers cannot or may not carry or use their mobile phones during performance of their services and so paying via mobile phone exchange using mobile applications is often not possible. There needs to be a way to overcome the problem of consumers not having cash for gratuity, and service providers not having to carry mobile phones while on duty in order to interact with consumers.

In light of the above, there is a need for apparatus that can provide consumers an easy way to locate nearby service providers and tip these “strangers” without actually having their contact information.

### BRIEF DESCRIPTION OF THE DRAWINGS

FIG. 1 illustrates consumers and different types of service providers in distinct and separate locales. The figure shows also that wireless badges, GPS badges, and QR badges on Service Providers in each vicinity are accessible by only mobile phones in the same vicinity.

FIG. 2 shows a software subsystem diagram of the Gratuity Server that pictures all of its internal special purpose subsystems.

FIG. 3 illustrates a mobile application with service providers listed that are in proximity.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers all such modifications and variations within the scope of the appended claims and their equivalents.

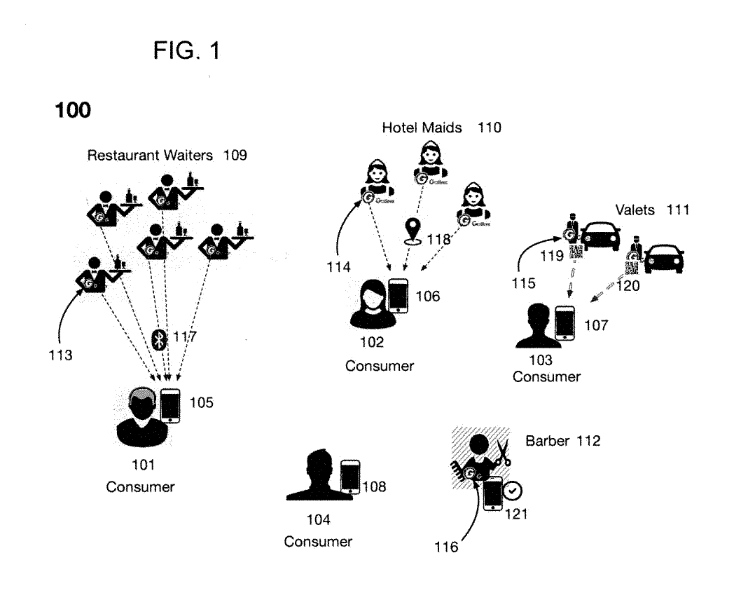

FIG. 1 illustrates four different service vicinities with associated different types of Service Providers. Each service vicinity is associated with a Service Entity such as a specific Restaurant, Hotel, or other place of business. 101 through 104 represent Consumers that are each located at each distinct vicinity with their Gratuity Mobile Applications on mobile phones (105-108), and are located at distinct Service Entities. The Service Providers (109-112) each have a badge (113-116), which provides nearby Gratuity Mobile Applications (105-108) information about which Service Providers are nearby. Wireless badges (117) continually transmit a code using Bluetooth or other wireless technology that represents their personal unique Service Provider ID. GSP badges (118) determine their geographic coordinates and send both the Service Provider ID and coordinates to a server. QR badges (115) have QR Codes (119-120) that may be scanned by Consumers (103-104) when they are next to the Service Providers. Virtual Badges (121) are those that don't physically exist but which are represented in the Global Mobile Application when a Service Provider uses the Global Mobile Application (121) to check-in at their Service Entity. Regardless of the badge type, the Service Entity local for a Service Provider is known,

The Service Provider is considered to be “on duty” until some mechanism determines that they are no longer in the locale. This may not always be easy to determine and sometimes cannot be determined. However, when it is determined, this can be noted by the system and even mark this fact next to a Service Provider displayed in the application. GPS Badges (118) are the easiest to determine exit from a vicinity. Check-ins using the Global Mobile Application (121) may be followed later using the Global Mobile Application (121) to check-out as well. Wireless Badges (113, 117) can be used as well but only to the extent that received nearby Service Provider IDs are regularly being received by a Consumer with a nearby Global Mobile Application (121) which, in turn, interacts with a server, but then it gets noticed that the Service Provider ID is no longer being received with Consumers in the same area.

Some embodiments will deploy a low cost Wireless Badge (113, 117) that only transmits (doesn't receive) and uses a low frequency and low power. Whereas some wireless badges can also receive, the simplicity of this badge and its low frequency and power beneficially realizes low initial and ongoing cost.

Nearby mobile phones running the Gratuity Mobile Application (105-108) will wirelessly see a list of nearby Service Providers, which may include Service Providers' photos to assist identification. This ability to get a list of Service Providers that are nearby so easily is a superior approach to typing in a Service Provider ID, or even typing or selecting the Service Entity that the Service Providers work at. However, when multiple service businesses are crowded together, an additional Service Entity filter may be necessary.

Embodiments employing QR badges (119-121) have an advantage over Wireless Badges in crowded Service Entity areas, since scanning the QR badge on a person (119-121) will immediately show the Service Provider that a Consumer desires to submit a gratuity to.

What a single or list of proximal Service Providers beneficially realizes, however, is that a Consumer will see the badge on a Service Provider and know not only that they are registered in the Gratuity system, but that they are on duty and available to easily give a gratuity to them. Thus, the Gratuity Badge solves the problem of listing all Service Providers of a nearby Service Entity that are on duty. Without the wireless or QR badge mechanism (113-116), the Gratuity Mobile Application (105-108) would not be able to know precisely who is on duty and so it would display all Service Providers of a Service Entity, even those that are not on duty, making browsing and selecting more confusing.

While the list includes the ability for a Service Provider to show a photo for better identification, they don't have to show a photo and can have Consumers select their Service Provider ID that is printed on their badge. This ID can be a user ID with a real name or even a funny or weird name as many people employ for their email IDs. Similarly, a service provider could show only their photo and no friendly human readable user ID. The important thing is that there is a way for a Consumer to easily identify a Service Provider in the list that they will be presented.

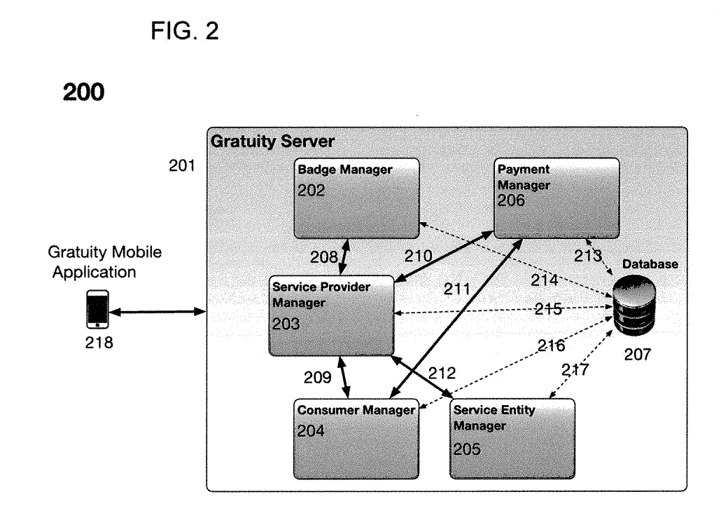

Once nearby Service Providers are found, internal to the Gratuity Mobile Application, they must be authenticated with the Gratuity Server (201) in FIG. 2 before they are displayed. The Service Provider IDs retrieved by a Consumer's (101-104) Gratuity Mobile Application (218) are sent to the Badge Manager (202). The Badge Manager (202) interacts with the Service Provider Manager (203) and Service Entity Manager (205) to authenticate that the Service Provider ID given is registered (checks database via 214), and if associated with a Service Entity (212 via 208), that the location that the Service Provider ID was found correlates with the correct Service Vicinity for the Service Entity associated. Service Providers that fail authentication are marked and the authentication results for all Service Providers is returned to the Gratuity Mobile Application (218). Some embodiments may present non-authenticated Service Providers with a visual mark and disallow further activity while other embodiments may simply not present them at all by performing the server authentication prior to display of the Service Providers received from the wireless badges.

One embodiment of the present invention marks the Service Provider when displayed with their Badge Type. This can denote the accuracy and authenticity of the Service Provider's presence. For example, Wireless Badges and GPS Badges have high accuracy and authenticity of location.

QR Codes and Check-in via the application do not necessarily have high authenticity and accuracy since can be performed anywhere in the world. However, one embodiment looks at the IP address where the QR scan or Check-in via application took place and correlates the IP address with a geographic location. Persons familiar with social and business applications will be aware that such mapping databases can be purchased, licensed, or subscribed to as a service.

The present invention beneficially allows Consumers to perform searches on Service Providers even when they are not nearby the Service Entity that Service Providers work for. Searches include geographic searches via map, listing a Service Entity, city, keywords, or any other means to denote a locale approximately or precisely. This beneficially provides the means for Consumers to know when a particular Service Provider is on duty that they really like. Some Consumers frequent Service Entities only for a specific Service Provider or Providers and only want to visit when the Service Provider or Providers are on duty.

One embodiment employs a Global Mobile Application implement that provides the means for Consumers to add Service Providers into “Favorites”. The “Favorites” list can be viewed and or a check box filter for “favorites only” may be employed during regular searching. A “Favorite” that shows up in a list should be marked with a small red heart. Favorites that match a search should present at the top of the search results list.

One embodiment employs a Global Mobile Application implement that provides the means for Service Providers to add Consumers into “Favorites”. When a Service Providers marks “Only Favorites see me Remotely”, then the Service Provider will not show up in lists unless the Consumer is nearby. This gives better privacy from stalkers but won't be perfect since people tend to know Service Provider schedules anyhow. However, we don't want to make it easier for stalkers to know when a person is on duty if a Service Provider wants some privacy.

The Manager subsystems also perform all “on-boarding” operations. Consumers can register, wherein this activity interacts with the Consumer Manager (204). They set up their account including their payment information. They also can eventually delete their account via the Consumer Manager (204) as well. All information is stored, updated, and deleted via 216 in the database (207). Similarly, Business owners or even employees (service providers) can set up a Service Entity so they can associate themselves with it in the system for searching and so that consumers see the association to a registered business. This is done with the Service Entity Manager subsystem. Again, All information is stored, updated, and deleted via 217 in the Database (207).

When a Service Provider acquires a Wireless Badge, they will see it appear in the Gratuity Mobile Application (218). They can then associate it with their Service Provider Account, which employs the Badge Manager (202) for set up. When they want to disassociate it or delete their account, the Badge Manager (202) is again employed which interacts (214) with the Database (207). The Service Provider Badge and Service Entity Association is stored via 215 in the Database (207).

Meanwhile, when a Consumer decides to pay a gratuity to a Service Provider, the Consumer Manager interacts via 211 with the Payment Manager (206) which will read stored payment information via 213 from the Database (207) as necessary depending on the payment mechanics of an embodiment. Some embodiments may incorporate their own currency in the system itself. Gratuity exchange is then done via the proprietary currency. Clearly the currency has no value unless it can be converted into and out of real currency or be employed to buy things from somewhere. Other embodiments' implementation of the Payment Manager will employ processing with credit card systems or Paypal. The Payment Manager then can interact via 210 with the Service Provider to make sure that they are authentic and receive the gratuity.

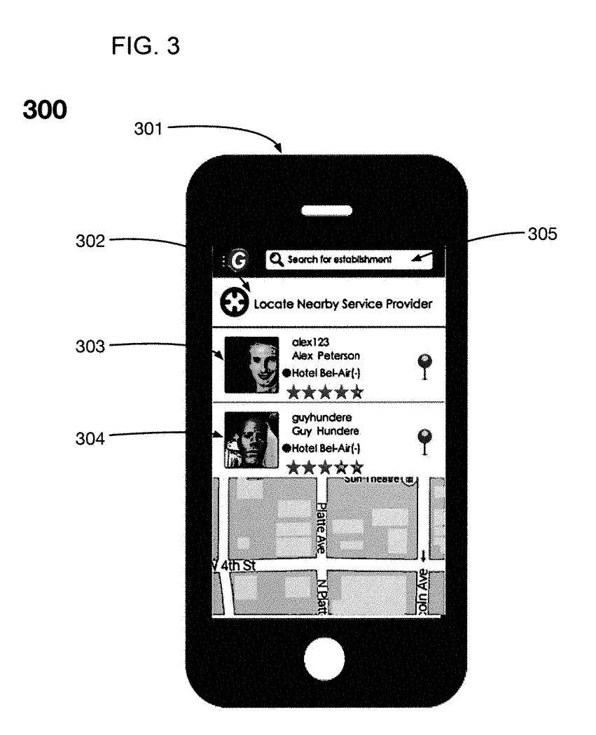

FIG. 3 depicts the salient portion of the Gratuity Mobile Application (301) graphical user interface that shows the list of nearby Service Providers at Hotel Bel-Air. A button (302) may be pressed to activate the discovery of proximal Service Providers as shown in the figure. Some embodiments may obviate the need for a button by just updating in real-time continuously.

Once nearby Service Providers are ready to be listed, their user IDs and photos are displayed (303 and 304). As alluded to earlier, however, an embodiment may support Service Provider accounts with privacy controls to enable and disable photos, names, and user IDs. Service Providers must realize, however, that they perform a public function and can't be completely private or they won't be able to be identified.

A simple keywords filter field (305) is also available to refine search results further. Again, the benefit of the wireless badges in conjunction with the Gratuity Mobile Application (301) is that the Service Providers listed are likely to be already refined enough. However, as mentioned some Service Entities conduct business in malls or other crowded buildings or areas and so on duty Service Providers from distinct Service Entities will appear as nearby results. The filter field (305) can assist to refine results better. Some embodiments may choose to provide a select filter that shows only

Service Entities that are nearby, thus making it even easier to refine results in crowded Service Entity vicinities.

Some embodiments may employ a sound or light enhanced wireless badge. In this case, the badge can generate an audible, vibration, or glow to let a Service Provider know that they have received a gratuity. In many cases, the Service Provider will know who it is since the Consumer will still be nearby.

More sophisticated embodiments will incorporate display enhanced wireless badges with an LCD, LED, or other display mechanism to show how much the gratuity is for. Some embodiments have color, grey-scale, or blinking lights (with low to high blink frequency) that can be used to show ranges of gratuities when numeric displays aren't available.

Other embodiments with display-enhanced badges can use any one of the well-known notification or display techniques to let the Service Provider know that a nearby Consumer, for any number of purposes, needs them.

Other embodiments with display-enhanced badges have a screen to present short messages to a Service Provider sent by a consumer (or patron). For example, a patron can request something via such a message from the Service Provider at a restaurant so that they don't have to wait for the Service Provider to return to their table. Another example is for a consumer to request a valet to retrieve an item from their car, or let them know they are going to arrive to the valet area soon to get their car.

Some embodiments use a mobile app on the Service Provider's phone to see such messages from consumers and even allow the Service Provider to send a message or reply to a consumer's message.

Other embodiments with enhanced wireless badges can support a consumer sending a group message to all Service Providers at the same service entity.

One embodiment of the present invention employs badges on physical objects instead of persons. In this case, an object may be stationary or regularly be sometimes or continually in motion. Regardless of which case it is, an object badge will most likely be either a tiny wireless badge or QR code attached to the object. However, it is possible that a person could check-in for an object using a mobile app, in particular, if the object is stationary. Whichever the case is, any person using a mobile app who is nearby the object will list the object in the mobile app either because it wirelessly received the unique identifier, the person scanned the QR identifier, or because the object is checked-into the nearby locale.

An embodiment that employs object IDs in the manner described above may then be employed to get information about the nearby object that may be used for a variety of purposes. One purpose is to simply get information, for example, at a museum where each distinct exhibit has an object badge identifier.

One embodiment purposes the object ID to be employed to retrieve a price in a retail store. More advanced embodiments will even provide the means to pay for the object right there.

One embodiment purposes the object ID to be attached to rides at a theme park in order to provide information about a ride. An advanced embodiment will even provide the means to use a digital ticket or pay for the ride.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

What is claimed is:

1. A networked and distributed system comprising badges with unique identifying information, mobile applications, and a server subsystem which together execute a computer implemented method across these distributed subsystems, the computer-implemented system comprising:
server subsystem;
obtaining nearby IDs into a running mobile phone application;
display that lists all available and nearby ID associations including identifying information such as ID, name, and photo;
list in mobile phone application for selecting one of the listed ID associations found.

2. The system of claim 1 wherein the selected Service Provider has their profile information retrieved from the server subsystem and displayed on the mobile application.

3. The system of claim 1 wherein the selected Service Provider is paid a gratuity.

4. The system of claim 1 further comprising badges which emit the unique identifying information wirelessly.

5. The system of claim 1 further comprising badges which emit the unique identifying information and GPS coordinate information wirelessly.

6. The system of claim 1 further comprising badges which have a QR code which represents the unique identifying information and is received into the mobile app when scanned via the phone's camera.

7. The system of claim 1 further comprising displaying all available nearby service providers who are also authenticated with the server subsystem.

8. The system of claim 1 further comprising virtual badges which are represented by the service provider checking-in to their place of service using the mobile app.

9. The system of claim 1 further comprising authenticating all mobile phone application received service provider ids with the server subsystem.

10. The system of claim 1 further comprising visual indicator next to each Service Provider to know which badge type a Service Provider is using.

11. The system of claim 1 further comprising means for consumer to create a list of favorite Service Providers.

12. The system of claim 1 further comprising means for Service Provider to create a list of favorite consumers.

13. The system of claim 1 further comprising means to submit a search using one or more criteria.

14. The system of claim 13 further comprising means to submit a search using keywords.

15. The system of claim 13 further comprising means to submit a search using a selected service entity.

16. The system of claim 13 further comprising means to submit a search using favorites only.

17. The system of claim 13 further comprising means for a Service Provider to select a privacy option to avoid showing up in search results.

18. The system of claim 12 further comprising means for the consumer searching on Service Providers with privacy option set still show up in searches when the Service Provider has the consumer performing the search in their favorites list.

19. The system of claim 1 further comprising means for a consumer to send a message to a Service Provider.

20. The system of claim 19 further comprising means for a Service Provider to:
send a message to a consumer;
send a message reply to a consumer.

21. The system of claim 19 further comprising means for a consumer to send a group message to all Service Providers of the same service entity.

22. The system of claim 1 further comprising means to manage its own proprietary currency.

23. The system of claim 1 further comprising means to manage the Server Provider ID as an Object ID.

24. A method comprising:
receiving nearby unique identifying information IDs from badges to a running mobile phone application;
displaying in a list, all nearby badge ID associations including their identifying information such as ID, name, and photo;
selecting in the mobile phone application one of the listed ID associations found.
